(19) United States
(12) Patent Application Publication
(10) Pub. No.: US 2011/0262333 A1
(43) Pub. Date: Oct. 27, 2011

(54) Controlling ammonia flow in a selective catalytic reduction system during transient non-steady-state conditions

(75) Inventors: Mark A. Buzanowski, Carrollton, TX (US); Sean P. McMenamin, Plano, TX (US); Tim Shippy, Frisco, TX (US)

(73) Assignee: Peerless Mfg. Co., Dallas, TX (US)

(21) Appl. No.: 12/766,313

(22) Filed: Apr. 23, 2010

(51) Int. Cl. B01D 53/56; G05B 21/00; G05D 7/00

(52) U.S. Cl. 423/239.1; 422/111; 700/273

(57) ABSTRACT

A selective catalytic reduction (SCR) system is defined that uses the measured concentration of reactant slip in the exhaust gas after SCR processing to control the amount of reactant injected during non-steady-state operational conditions. The SCR system works with a reactant slip detector located in the post-SCR processing section of the exhaust flue. The reactant slip detector measures the concentration of reactant in the exhaust gases and, based on that concentration, the amount of reactant injected into the pre-SCR processing exhaust gases is controlled.

### TECHNICAL FIELD

The present disclosure relates, in general, to selective catalytic reduction (SCR) systems, and, more particularly, to control of ammonia flow in an SCR system during transient non-steady-state conditions.

### BACKGROUND

The general term, “nitrogen oxides” (NOₓ), is used to describe a group of molecules that contain varying amounts of nitrogen and oxygen at certain ratios. The specific make up of NOₓ usually depends on the particular valence state of the nitrogen elements (e.g., valence states for the nitrogen typically ranging from one to five) and the number of oxygen ions present. The number of oxygen ions depends on the particular valence state. A NOₓ molecule exists where the number of oxygen ions is equal to the valence state number minus two. NOₓ generally forms at high temperatures during fossil fuel combustion of some sort. In the United States, the primary sources of anthropogenic NOₓ emissions are motor vehicles, power plants, and other commercial, industrial, and residential sources that combust fossil fuels. Direct NOₓ emissions from these sources include several different forms, such as nitrogen dioxide (NO₂), nitrous oxide (N₂O), and nitric oxide (NO), however, NOₓ generated during combustion is primarily produced in the form of NO. NOₓ emissions react with other compounds, such as those compounds considered or classified as volatile organic compounds (VOCs), in the troposphere to form secondary products that include ozone (O₃), nitric acid (HNO₃), nitrate particles, and the like. NOₓ emissions are air pollutants by themselves and precursors to formation of ozone (i.e., smog) and acid rain. To protect public health, concentrations of NOₓ and ozone in the ambient atmosphere are subject to air quality standards established in the United States by the Environmental Protection Agency (EPA). Because of the potentially negative health and environmental impacts associated with NOₓ emissions and their role in generating tropospheric ozone, NOₓ emissions producers are often highly regulated by the EPA, as well as by state and local environmental authorities.

One process that has been developed to remove NOₓ from emission gases is referred to as selective catalytic reduction (SCR). SCR is a process that reduces the concentration of NOₓ in the emission gases by converting the NOₓ into diatomic nitrogen (N₂) and water (H₂O) molecules, which are not considered pollutants. This conversion is performed with the aid of a catalyst and a gaseous reductant or reactant, which is typically ammonia (NH₃), the source of this ammonia in the system is often derived from anhydrous ammonia, aqueous ammonia, urea, or the like. The ammonia is added to the stream of NOₓ-containing flue or exhaust gas (i.e., emission gas) prior to interaction with the catalyst. As this mixture of ammonia and NOₓ passes through the catalyst bed at operational temperatures, a high percentage of NOₓ reacts with ammonia on the catalyst surface decomposing into diatomic nitrogen and water molecules, thereby reducing the NOₓ level in the emission gas.

Within an operational SCR system, the actual amount of NO converted or removed depends, in large part, on the chemical composition of the catalyst bed and the relationship (i.e., the stoichiometric ratio) between the amount of ammonia injected and the amount of NOₓ in the exhaust gas. However, determining the correct amount of ammonia to inject can be quite complex. If less than the appropriate amount of ammonia is injected, the desired NOₓ reduction will not be met. Failing to meet this reduction potentially subjects the process operator to governmental fines and penalties and possible shut-down of the process facility, any of which could have serious business and public health consequences.

FIG. 1 is a block diagram illustrating exhaust system 10 configured using a known example SCR NOₓ reduction system. Exhaust flue 100 contains exhaust gases emitted from a combustion source (not shown). An amount of inlet NOₓ, NOₓ 101, is present in the exhaust gases traveling through exhaust flue 100 at the inlet to the SCR reactor chamber 104. The amount of inlet NOₓ in NOₓ 101 is usually measured in a “parts per” notation, such as parts per million (ppm) (100 micrograms per cubic meter), parts per billion (ppm), and the like. This measurement notation provides the concentration of the NOₓ in a given amount of exhaust gas examined. The measured amount reflects the particular concentration of NOₓ at a NOₓ detector (not shown) making the measurement at the inlet. It is possible for a higher or lower concentration of NOₓ to exist in the exhaust gases if there is a different NOₓ concentration in the area surrounding the detector than in other parts of exhaust flue 100. When flowing through with the exhaust gas, the total amount of NOₓ 101 is spread out over the cross-sectional area of exhaust flue 100 in a somewhat random distribution, as illustrated by the NOₓ arrows drawn in FIG. 1. In order to estimate the total concentration of NOₓ 101, various known statistical methods may be used.

As the exhaust gas travels through exhaust flue 100, ammonia, from ammonia reservoir 103, is added to the gas through injection grid 102. The injected ammonia mixes with NOₓ 101 in the exhaust gas as it continues into reactor chamber 104. The resulting concentration of ammonia in the inlet exhaust gas is also measured with a ppm, ppb, or the like, notation. Reactor chamber 104 includes catalyst bed 105, which provides exposure of the exhaust gases to the reduction catalyst. SCR catalysts are generally manufactured from various ceramic materials used as a carrier, such as titanium dioxide, and active catalytic components are usually either oxides of base metals (such as vanadium and tungsten), zeolites, and/or other various precious metals. When operating at a proper temperature, the catalyst adsorbs ammonia on the active sites of catalyst bed 105. As the adsorbed ammonia comes into contact with the gaseous NOₓ, a chemical reaction occurs that allows incoming NOₓ 101 to decompose into nitrogen and water molecules, thus, reducing the amount of NOₓ 101 exiting reactor chamber 104. The total amount of the reduction is limited by the composition of the catalyst. Thus, at some point, the SCR process will not be capable of converting or reducing any more NOₓ because all of the catalyst sites are activated.

Upon exit of reactor chamber 104, NOₓ detector 106 measures the remaining NOₓ, NOₓ 107, in the exhaust gas. SCR systems are typically capable of removing over 90% of NOₓ in exhaust gases when the proper catalyst levels and system parameters, such as temperature, are present. In addition to NOₓ 107, the exhaust gas will also include ammonia slip 108. Ammonia slip 108 is the unreacted ammonia remaining in the exhaust gas that either was unreacted because catalyst operating conditions, such as, for example, operating temperatures, were not optimal or because too much ammonia was injected into the process in relation to the amount of catalyst or concentration of NOₓ. The steady-state SCR process operates optimally when there is a unitary molar relationship between the input NOₓ, NOₓ 101, and the injected ammonia concentration. If there is an imbalance of this molar relationship and locally, more ammonia than NOₓ is supplied, ammonia slip 108 will be present. An imbalance is typical in actual operation of SCR systems. Therefore, ammonia slip 108 is usually assumed to be present in such systems.

Because this molar relationship between NOₓ 101 and the injected ammonia is important to the efficient and effective reduction of NOₓ, various systems have been developed to control and tune the ammonia injected into an SCR system. Returning to the example of FIG. 1, data from NOₓ detector 106 is typically fed back into controller 109 to determine how to adjust the amount of ammonia being injected at injection grid 102. Control signals are transmitted to ammonia reservoir 103 indicating whether more ammonia is to be added, less ammonia, or the same amount, in order to achieve the desired concentration of exhaust NOₓ, NOₓ 107.

Still other systems gauge ammonia injection based on the measured or expected amount of inlet NOₓ 101. These feed-forward systems, then, control ammonia based on the amount of NOₓ at the inlet to the SCR system. Whether the exhaust system employs feedback methods, such as exhaust system 10, feed-forward systems, or some combination of the two, or other controls, e.g., model-based predictive techniques the important and complex task is to inject the appropriate amount of ammonia into the SCR system at any given time of steady-state operation.

### BRIEF SUMMARY

Embodiments of the present teachings are directed to an SCR that uses the measured concentration of reactant slip in the exhaust gas after SCR processing to control the amount of reactant injected during non-steady-state operational conditions. The SCR system works with a reactant slip detector located in the post-SCR processing section of the exhaust flue. The reactant slip detector measures the concentration of reactant in the exhaust gases and, based on that concentration, the amount of reactant injected into the pre-SCR processing exhaust gases is controlled.

Representative embodiments of the present teachings are directed to methods for controlling reactant injection into an SCR system during non-steady-state operational conditions. These methods include measuring a concentration of reactant in exhaust gases exiting the SCR system, comparing the measured concentration to an expected reactant concentration, transmitting a first signal to decrease the reactant injection prior to the SCR system in response to the measured concentration exceeding the expected reactant concentration, and transmitting a second signal to increase the reactant injection in response to the expected reactant concentration exceeding the measured concentration.

Additional representative embodiments of the present teachings are directed to reactant injection control mechanisms for SCR systems during non-steady-state operational conditions. These reactant injection control mechanisms include means for measuring a concentration of reactant in exhaust gases exiting the SCR system, means for comparing the measured concentration to an expected reactant concentration, means, executable in response to the measured concentration exceeding the expected reactant concentration, for transmitting a first signal to decrease the reactant injection, and means, executable in response to the expected reactant concentration exceeding the measured concentration, for transmitting a second signal to increase the reactant injection.

Further representative embodiments of the present teachings are directed to computer program products having a computer-readable medium with program code recorded thereon. The program code in these computer program products includes code to measure a concentration of reactant in exhaust gases exiting an SCR system, code to compare the measured concentration to an expected reactant concentration, code, executable in response to the measured concentration exceeding the expected reactant concentration, to transmit a first signal to decrease the reactant injection, and code, executable in response to the expected reactant concentration exceeding the measured concentration, to transmit a second signal to increase the reactant injection.

Still further representative embodiments of the present teachings are directed to emissions control systems that include an exhaust flue configured to contain exhaust gases produced by a pollution source, the pollution source coupled to the exhaust flue at a first end, a reaction chamber positioned between the first end and a second end of the exhaust flue, the reaction chamber containing a catalyst bed, and an injection grid within the exhaust flue prior to the reaction chamber, the injection grid coupled to a reactant reservoir, wherein the injection grid injects reactant from the reactant reservoir into the exhaust gases within the exhaust flue. The emissions control systems also include a reactant injection controller coupled to the injection grid, wherein the reactant injection controller transmits signals to the reactant injection controller controlling an amount of the reactant injected into the exhaust gases, a reactant detector within the exhaust flue after the reaction chamber, the reactant detector coupled to the reactant injection controller, wherein the reactant detector measures a concentration of reactant in the exhaust gases after passing over the catalyst bed in the reaction chamber, and a pollution source monitor coupled to the reactant injection controller, wherein the pollution source monitor monitors an operational condition of the pollution source, wherein, in response to the pollution source monitor detecting the pollution source in a non-steady-state operational condition, the pollution source monitor signals the reactant injection controller to use the concentration measured by the reactant detector in controlling the amount of the reactant injected into the exhaust gases during the non-steady-state operational condition.

The foregoing has outlined rather broadly the features and technical advantages of the present teachings in order that the detailed description that follows may be better understood. Additional features and advantages will be described hereinafter which form the subject of the claims. It should be appreciated by those skilled in the art that the conception and specific embodiments disclosed may be readily utilized as a basis for modifying or designing other structures for carrying out the same purposes of the present teachings. It should also be realized by those skilled in the art that such equivalent constructions do not depart from the technology of the teachings as set forth in the appended claims. The novel features which are believed to be characteristic of the teachings, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present teachings.

### BRIEF DESCRIPTION OF THE DRAWINGS

For a more complete understanding of the present teachings, reference is now made to the following description taken in conjunction with the accompanying drawings.

FIG. 1 is a block diagram illustrating an exhaust system configured using a known example SCR NOₓ reduction system.

FIG. 2 is a diagram illustrating NOₓ output emissions of a gas turbine generator from start-up through steady-state operation.

FIG. 3A is a block diagram illustrating a figurative example of SCR process of a combustion system at steady-state conditions.

FIG. 3B is a block diagram illustrating a figurative example SCR process during a first start-up time.

FIG. 3C is a block diagram illustrating a figurative example SCR process during another start-up time.

FIG. 4 is a block diagram illustrating an exhaust system configured according to one embodiment of the present teachings.

FIG. 5A is a block diagram illustrating a figurative example SCR process configured according to one embodiment of the present teachings and operating during a transient, non-steady-state period.

FIG. 5B is a block diagram illustrating a figurative example SCR process operating during another transient, non-steady-state period.

FIG. 6 is an operational block diagram illustrating example functional blocks executed to implement one embodiment of the present teachings.

FIG. 7 is a block diagram illustrating a computer system which may be employed to implement various embodiments of the present teachings.

### DETAILED DESCRIPTION

Many exhaust systems that use the SCR process are designed to operate at the steady-state of the underlying combustion process. The facilities for which such exhaust systems are used typically operate most of the time in a steady-state condition. Therefore, the control schemes are designed for the times at which the systems are operating most. For example, in gas turbine power generators, this steady-state comprises the state in which the gas turbine is up and running at operational speeds and the SCR system has reached the optimal temperatures which allow the chemical equilibrium reaction to occur with the catalyst. One of the problems in the current control schemes for SCR processes is how to handle transient, non-steady-state conditions, e.g., start-up, shut-down, heavy-loading and unloading, and the like. In these transient conditions, the operating conditions cannot be assumed to be the same as in steady-state. Therefore, the SCR system will generally not operate as designed or will not achieve the expected steady-state performance as designed within a tight time tolerance.

It should be noted that, during startup transitions, the SCR process experiences continuous non-steady-state operation. The startup condition itself is a transient state or condition in the operation of the underlying process. However, the non-steady-state conditions that occur during startup, or most other transient states, is continuous. These transient startup conditions include parameters, such as low exhaust gas temperature, insufficient catalyst volume, abnormal levels of pollutants, and the rapid rate of change of these operating parameters, plays a role in the dynamics and effectiveness of the SCR process during such transient, non-steady-state operations.

For example, during startup in a gas turbine generator, the amount of inlet NOₓ may greatly exceed the normal values present during steady-state due to specific startup combustion conditions or different startup combustion modes. Moreover, because of these varying startup conditions and modes, the concentration of inlet NOₓ changes very rapidly over a short period of time. Therefore, even if there were a control mechanism able to keep up with adjusting the ammonia injection based on the inlet or outlet NOₓ, an existing SCR system would still not be capable of reducing the outlet NOₓ to the targeted set point (e.g., if the concentration of NOₓ at the inlet is 100 ppm and the SCR system is designed to reduce 90% of the NOₓ, then the resulting concentration of NOₓ at outlet NOₓ would, in ideal steady-state conditions, still be 10 ppm, which, if 2 ppm were the targeted set point, would be considerably greater than the set point concentration even when the system is operating properly at steady-state). Additionally, operating an SCR process during certain times of startup may not even achieve expected operation because temperatures have not reached optimal operational levels. For example, if the temperature has not reached the optimal level, even though a particular catalyst bed is designed to provide a 90% reduction, because the temperature is not sufficient for the entire catalyst bed to operate effectively, the same catalyst bed may operate only at 50% or maybe even not at all. Thus, existing SCR systems experience vastly different conditions in these transient non-steady-state conditions which are not addressable by the current control systems designed for steady-state operation.

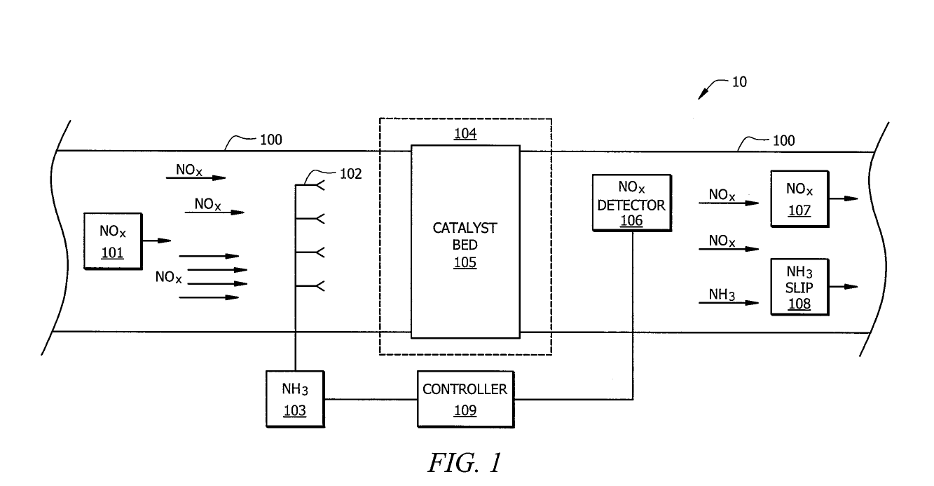

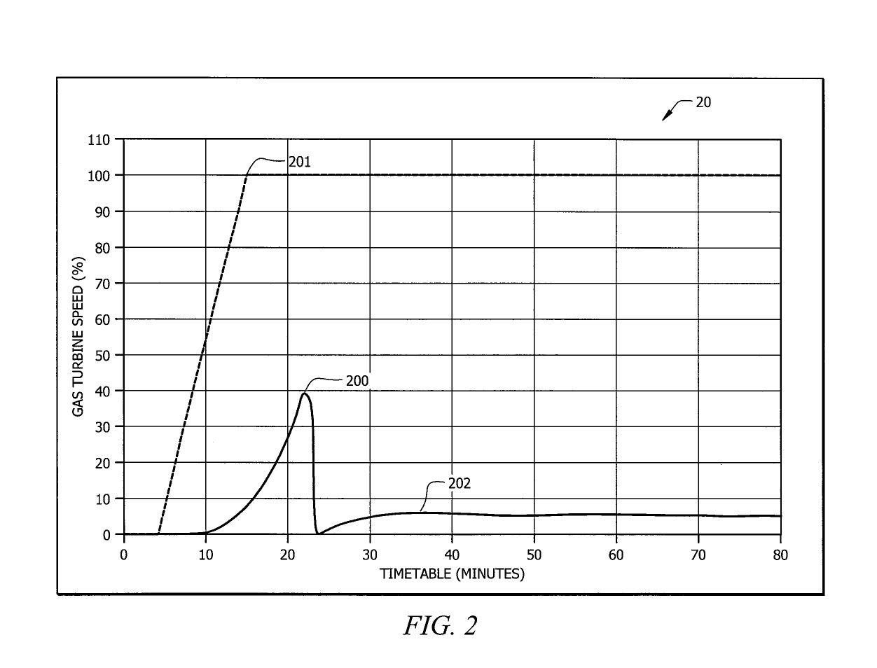

FIG. 2 is a diagram illustrating NOₓ emissions from a gas turbine generator with dry low NOₓ (DLN) combustors beginning at start-up through steady-state operation. As the turbine speed increases in an essentially linear fashion from 0 to 100% in the start-up period, an exponential increase in NOₓ emission is measured at the inlet position (e.g., NOₓ 101 of FIG. 1). The maximum NOₓ emission is reached at time 200 (approximately 20 minutes after startup), sometime after the turbine reaches 100% speed at time 201 (approximately 12 minutes after startup). After approximately 35 minutes, at time 202, the turbine has reached its steady-state operation, in which the combustion within the turbine now produces a steady-state level of NOₓ. The entire excessive NOₓ period lasts only approximately 10 minutes. However, a considerable amount of NOₓ may be released into the atmosphere during these 10 minutes. The rapid change of inlet NOₓ could not be handled by the current feedback and feed-forward SCR systems. In feed-forward systems, by the time an inlet NOₓ detector finishes measuring the inlet NOₓ, the amount of inlet NOₓ could be substantially different. Similarly, using a feedback system that measures the control variable based on the outlet NOₓ, by the time the outlet NOₓ is measured, the inlet NOₓ may again be substantially different. This assumes that the temperatures in the system are even adequate for proper catalyst operation. Thus, the unpredictable temperatures and rapid change of inlet NOₓ at startup reveals that current feedback and feed-forward SCR systems are inadequate to effectively handle NOₓ reduction with such transient operating conditions. Moreover, there are currently no viable solutions that address this problem sufficiently. In fact, governmental authorities have mostly given exemptions from NOₓ reduction regulations for such transient non-steady-state conditions. Thus, existing facilities generally do not even operate their SCR systems during such transient conditions.

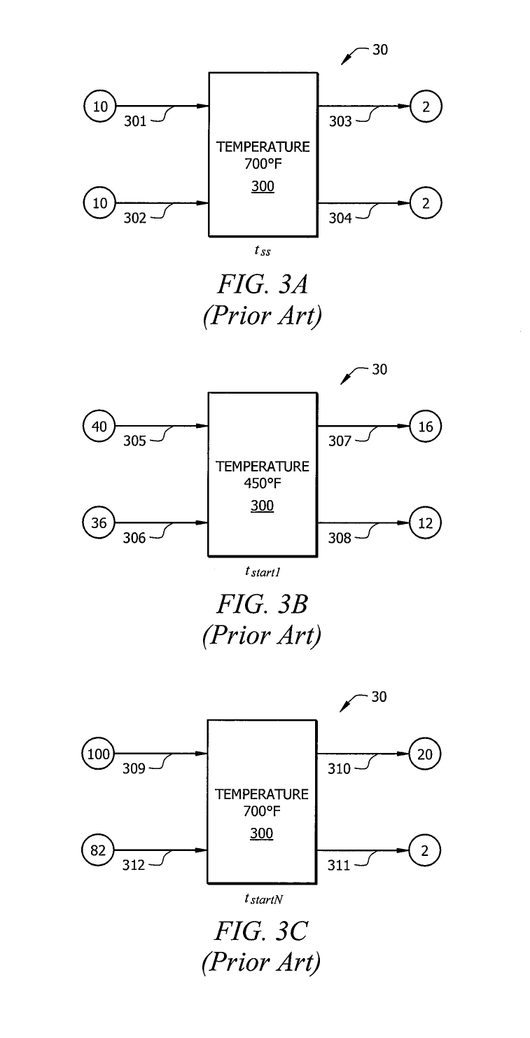

Turning now to FIG. 3A, a block diagram is shown illustrating a figurative example of SCR process 30 for a combustion system at steady-state conditions. The temperature of SCR process 30 is a fully operational temperature of 700° F., at tₛₛ. SCR process 30 includes catalyst bed 300, at which the reduction reaction occurs between inlet NOₓ 301 and inlet reactant 302. Catalyst bed 300 is selected for SCR process 30 to result in an 80% reduction of NOₓ at steady-state conditions. At time, tₛₛ, the combustion system is in a steady-state condition with expected operating temperatures and expected steady-state inlet NOₓ levels. The concentration of NOₓ at inlet NOₓ 301 is estimated based on operating conditions after which the corresponding concentration of reactant at inlet reactant 302 is determined. In the steady-state example of FIG. 3A, inlet NOₓ 301 contains a concentration of 10 ppm NOₓ, while inlet reactant 302 contains a concentration of 10 ppm reactant. At the exit of catalyst bed 300, the SCR reaction produces outflow NOₓ 303 with a concentration of 2 ppm NOₓ. In this steady-state operation, the expected 80% reduction configuration of catalyst bed 300 is achieved because of sufficient operational temperatures and an expected concentration of NOₓ at inlet NOₓ 301.

SCR process 30 is designed to produce outflow NOₓ 303 at a particular set point (i.e., 2 ppm NOₓ) during steady-state. This set point may correlate to a particular emission regulation or other such rules. If, during steady-state, there are any fluctuations in the value of outflow NOₓ 303, a feedback mechanism signals to adjust the concentration of reactant at inlet reactant 302 in order to keep outflow NOₓ 303 at the desired set point concentration.

If SCR process 30 were activated during transient non-steady-state conditions, it would attempt to operate in the same manner as during steady-state because of its design configuration. However, as noted, during transient non-steady-state conditions, the same assumptions cannot be made as to the operation of SCR process 30. FIG. 3B is a block diagram illustrating SCR process 30 at start-up time, tₛₜₐᵣₜ₁. At time tₛₜₐᵣₜ₁, the concentration of NOₓ at inlet NOₓ 305 is 40 ppm. In order to generate the expected 80% reduction, inlet reactant 306 would, at steady-state conditions, be set to inject reactant to reach a concentration of 36 ppm reactant, which, under ideal steady-state conditions, should result in a concentration of NOₓ at outflow NOₓ 307 of 8 ppm and a concentration of reactant at reactant slip 308 of 2 ppm. tₛₜₐᵣₜ₁. However, SCR process 30 is not operating under steady-state conditions at time At time tₛₜₐᵣₜ₁, the temperature is 450° F., which is insufficient to support optimal catalytic reactions. Therefore, in operation, with an insufficient temperature, the actual resulting concentration of NOₓ at outflow NOₓ 307 is 16 ppm, or a reduction of only 40%. Because the temperature is insufficient for catalyst bed 300 to operate to its designed steady-state levels, an additional amount of reactant slip 308 is also present at the outflow. In this non-steady-state condition, the measured concentration of reactant at reactant slip 308 is 12 ppm.

The NOₓ feedback system of SCR process 30 detects that the concentration of NOₓ at outflow NOₓ 307 exceeds the set point and, thus, signals to increase the concentration of reactant at inlet reactant 306. However, one of the main reasons that the concentration of NOₓ at outflow NOₓ 307 exceeds the set point is because the temperature is insufficient for the catalytic reaction to take place throughout catalyst bed 300. Therefore, the existing outflow NOₓ-based control mechanism of SCR process 30 can increase the amount of reactant injected into inlet reactant 306 to almost any amount without resulting in any further appreciable reduction of NOₓ in outflow NOₓ 307. This is because the optimal operation of SCR process 30 is temperature dependent. If the temperature is not sufficient to trigger the catalytic reaction, then SCR process 30 cannot operate according to its designed specifications, regardless of the amount of reactant injected into the system.

FIG. 3C is a block diagram illustrating SCR process 30 at start-up time, t_{startN}. As illustrated in FIG. 2, the concentration of NOₓ in the exhaust gas from the combustion source continues to rise to a maximum level before finally reducing to its steady-state levels. At time t_{startN}, the concentration of NOₓ at inlet NOₓ 309 measures 100 ppm, and the temperature of SCR process 30 is an optimal temperature of 700° F. Again, SCR process 30 is designed to produce an 80% reduction in NOₓ at normal, steady-state conditions. Based on the level of inlet NOₓ 309, the SCR process determines to reach this 80% reduction by injecting reactant to a concentration of 82 ppm at injected reactant 312. Because operation takes place at the optimal operational temperature, SCR process 30 will reduce the concentration of NOₓ at outflow NOₓ 310 to a level of 20 ppm (i.e., by the expected steady-state amount of 80%) with a concentration of 2 ppm reactant at reactant slip 311. These levels result with SCR process 30 operating according to design. However, a concentration of 20 ppm NOₓ at outflow NOₓ 310 greatly exceeds the targeted set point for steady-state operations. Because the outlet NOₓ based control mechanism for SCR process 30 is designed to maintain the concentration of NOₓ at outflow NOₓ 310 at 2 ppm, a signal will be transmitted to increase the reactant injected into the inlet. However, the resulting concentration of NOₓ at outflow NOₓ 310 is achieved with SCR process already performing according to the maximum reduction rated for catalyst bed 300. In addition to being temperature dependent, the functionality of SCR process 30 is also catalyst dependent. This means that once the maximum reduction capacity of 80% has been reached for catalyst bed 300, no amount of additional reactant will appreciably increase the NOₓ reduction beyond that maximum capacity. Therefore, the control mechanism triggering additional reactant injected into SCR process 30 will more likely only result in a higher concentration of reactant at reactant slip 311.

It should be noted that, in designing a catalyst bed for an SCR process, a certain amount of additional catalyst is built into a given catalyst bed. This additional design margin or safety margin slowly reduces over the years of useful life of the catalyst bed. Thus, at the beginning of a particular catalyst bed lifespan, increasing reactant injection will have some additional reduction affect over the designed reduction percentage for that particular catalyst bed. However, this additional design margin is finite and it still limits the total amount of NOₓ reduction that the catalyst bed and SCR process can achieve at a given point in time. Moreover, toward the end of the useful life of the catalyst bed, this design margin no longer exists, in which case injecting additional reactant will have no increased reducing affect.

The control system for controlling SCR process 30 at steady-state is based on the measured concentration of NOₓ at outflow NOₓ 310 and the predicted NOₓ concentration at inlet NOₓ 309. This type of input/output NOₓ concentration design is widespread and is a logical design. The concentration of emitted NOₓ is the parameter that is at the center of the regulatory system. Therefore, using input and output NOₓ levels as control variables would appear to be warranted. However, neither of the control-related NOₓ variables is constant at steady-state conditions. Moreover, as shown in FIGS. 3B and 3C, this inconsistency is even greater at transient, non-steady-state conditions. Thus, as shown in FIGS. 3B and 3C, the hypothetical operation of current SCR control systems at transient, non-steady-state conditions has many limitations.

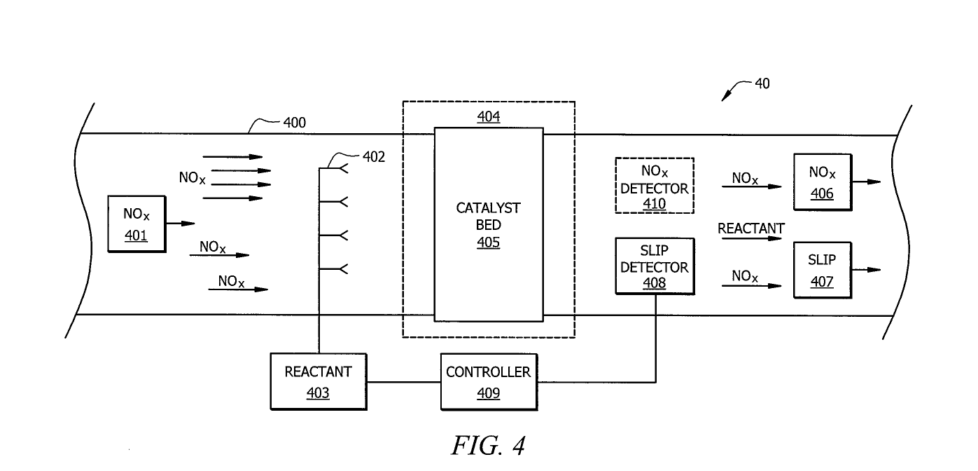

FIG. 4 is a block diagram illustrating exhaust system 40 configured according to one embodiment of the present teachings. The configuration of exhaust system 40 is nearly identical to that of exhaust system 10. Exhaust flue 400 contains the exhaust gases from a combustion source (not shown). The exhaust gases include inlet NOₓ 401, which is dispersed through the cross-sectional area of exhaust flue 400 in some distribution concentration, as reflected by the illustrated NOₓ arrows. Reactant gas from reactant reservoir 403 is injected into exhaust flue 400 using injection grid 402. The mixture of reactant and inlet NOₓ 401 enters reaction chamber 404 and is exposed to catalyst bed 405. At catalyst bed 405, the NOₓ reduction process (i.e., the SCR process) takes place, with the catalyst material adsorbing reactant molecules, which creates the condition in which the NOₓ molecules decompose into the constituent diatomic nitrogen (N₂) and water (H₂O). Based on the capacity of catalyst bed 405, the operational temperature, and the ratio of the reactant concentration to the concentration of NOₓ 401, resulting concentrations of NOₓ and reactant at residual outflow NOₓ 406 and reactant slip 407, respectively, exit reaction chamber 404. The processed exhaust gas, now with reduced outflow NOₓ 406 and reactant slip 407 continues through exhaust flue 400. Exhaust system 40 also includes reactant slip detector 408 and feedback controller 409 that operate together to control or adjust the amount of reactant injected at injection grid 402.

Of the described component pieces of exhaust system 40 only the addition of reactant slip detector 408 and removal of NOₓ detector 106 (FIG. 1) is different from the example existing exhaust system 10 described in FIG. 1. It should be noted, however, that various implementations of existing exhaust systems may also have such reactant slip detectors in order to monitor the amount of reactant in the post-processed emission gas. Moreover, example embodiments of exhaust systems configured according to the present teachings may have both reactant slip detectors and NOₓ detectors. For example, optional NOₓ detector 410 is illustrated in ghost to represent such additional embodiments with both reactant slip detector 408 and NOₓ detector 410. Therefore, the major component make-up of exhaust system 40 may be the same as existing exhaust systems. However, exhaust system 40 includes a reactant slip-based control mechanism that may be efficiently used during transient, non-steady-state conditions without wildly increasing reactant injection beyond effective reduction limits.

The feedback mechanism of exhaust system 10 (FIG. 1) uses the output NOₓ measurement from NOₓ detector 106 (FIG. 1) to determine any adjustment to be made to the injected reactant. In contrast, however, exhaust system 40 uses output reactant slip 407, as measured by reactant detector 408. Referring back to FIGS. 3A-3C, the variables on which the control of SCR process 30 (FIGS. 3A-3C) were based, i.e., predicted input NOₓ, outflow NOₓ, and operational temperature, are all rather widely variable in transient, non-steady-state conditions. However, in operations of SCR process 30 which were consistent with its designed configurations, the reactant slip, reactant slip 304, reactant slip 308, and reactant slip 311 (FIGS. 3A-3C), each remained at a relatively constant level. Therefore, by basing the feedback control on the more constant level of reactant slip, exhaust system 40 achieves a greater dynamic range of reduction effectiveness without needlessly injecting levels of reactant that the given temperature, catalyst volume, or combination of both cannot process.

As reactant slip detector 408 detects the concentration of reactant in the processed exhaust gas, information identifying that level is transmitted to controller 409. Controller 409 uses the reactant slip level to determine any changes that should be made to the amounts of reactant injected from reactant reservoir into exhaust flue 400 through injection grid 402. Any fluctuation in reactant slip 407 will provide a better indication of the efficiency of the reduction process occurring in reaction chamber 404. Moreover, because the feedback adjustment for reactant injection is based off of the resulting reactant slip 407 and not inlet NOₓ 401, outflow NOₓ 408, exhaust system 40 will be capable of providing NOₓ reductions at transient, non-steady-state operational periods without disproportionate injection of reactant that would be unusable by the SCR process of exhaust system 40.

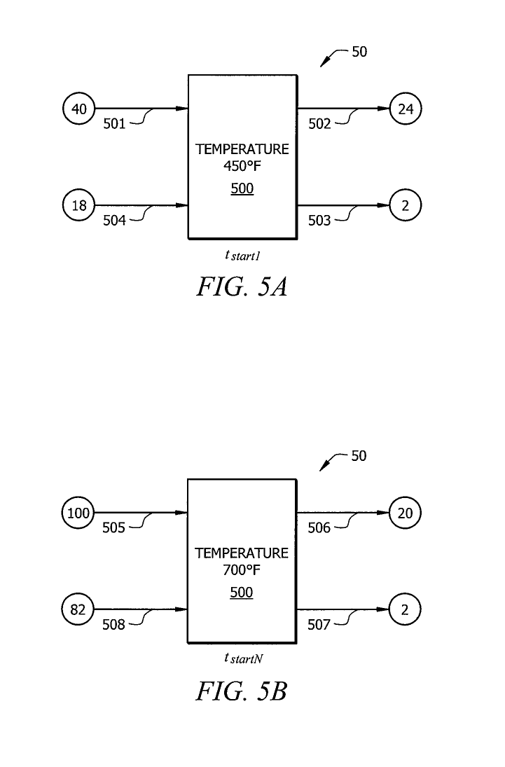

FIG. 5A is a block diagram illustrating SCR process 50 configured according to one embodiment of the present teachings operating during a transient, non-steady-state period. SCR process 50 is designed to operate at transient, non-steady-state periods, such as start-up time, tₛₜₐᵣₜ₁. The same conditions exist in startup time tₛₜₐᵣₜ₁, as reflected in FIG. 3B. The operating temperature at startup time tₛₜₐᵣₜ₁ is 450° F., which is insufficient for proper catalytic reaction in catalyst bed 500, and the concentration of NOₓ at inlet NOₓ 501 is 40 ppm. The configuration of catalyst bed 500 is the same as that of catalyst bed 300 (FIG. 3B). Thus, while catalyst bed 500 is designed to achieve an 80% reduction of NOₓ, at the operating temperature of 450° F., the reduction efficiency of catalyst bed 500 is reduced to 40%. In the illustrated embodiment, SCR process 50 is controlled based on a feedback of measured reactant slip at reactant slip 503. The control mechanism will cause reactant to be injected into the system until the concentration of reactant measured at reactant slip 503 reaches the targeted set point. In the example embodiment illustrated in FIG. 5A, this targeted set point is 2 ppm concentration of reactant. Therefore, reactant is injected until the concentration of reactant at reactant slip 503 reaches 2 ppm.

Considering the 40% operational reduction capacity at 450° F., a concentration of NOₓ at outflow NOₓ 502 reaches 24 ppm with a concentration of 18 ppm reactant at injected reactant 504. This combination of operating parameters results in a measured concentration of reactant at reactant slip 503 of 2 ppm, the targeted set point. With the set point reached, the reactant slip-based control mechanism of SCR process 50 ceases any signals to increase the level of reactant injection. The current level of reactant injection achieving the concentration of 18 ppm reactant at injected reactant 504 will continue until a variation in the concentration of reactant at reactant slip 503 from the targeted set point. This variation may occur as the operating temperature increases, in which case the concentration of reactant at reactant slip 503 will fall below 2 ppm, prompting the control mechanism to increase the level of reactant injection. The variation may also occur if, for some reason, startup is aborted, thus, causing the operating temperature to decrease, in which case the concentration of reactant at reactant slip 503 will begin to rise above 2 ppm, prompting the control mechanism to reduce the level of reactant injection. In such a case, at some temperature, the entire catalytic reaction will cease, prompting the injection of reactant to achieve a concentration of only 2 ppm at reactant slip 503 until the entire system is shut down.

FIG. 5B is a block diagram illustrating SCR process 50 configured according to one embodiment of the present teachings operating during another transient, non-steady-state period. SCR process 50 now operates at the transient, non-steady-state of startup time, t_{startN}. The same conditions exist in startup time t_{startN}, as reflected in FIG. 3C. The operating temperature at startup time t_{startN} is 700° F., which is sufficient for proper catalytic reaction in catalyst bed 500, and the concentration of NOₓ at inlet NOₓ 505 is 100 ppm. Again, the illustrated embodiment of SCR process 50 is controlled based on a feedback of measured reactant slip at reactant slip 503. Thus, the control mechanism will cause reactant to be injected into the system until the concentration of reactant measured at reactant slip 503 reaches the targeted set point of 2 ppm.

Now that the temperature is sufficient for full efficient operation, an 80% reduction will be achievable by catalyst bed 500. Thus, reactant will be injected into SCR process 50 until the concentration of reactant at reactant slip 507 reaches 2 ppm. This point occurs when the maximum 80% reduction is achieved with a concentration of NOₓ at outlet NOₓ 506 of 20 ppm. With the resulting reactant concentration of 2 ppm at reactant slip 507, the concentration of reactant at injected reactant 508 is 82 ppm. At this point, because the target set point has been reached at reactant slip 507, the control mechanism will not signal a further increase in reactant injection until a variation of the concentration at reactant slip 507 is detected. Therefore, unlike the NOₓ-based control mechanism of SCR process 30 (FIGS. 3A-3C), additional reactant injection will not be triggered solely because the resulting concentration of NOₓ at outlet NOₓ 506 is above a certain level.

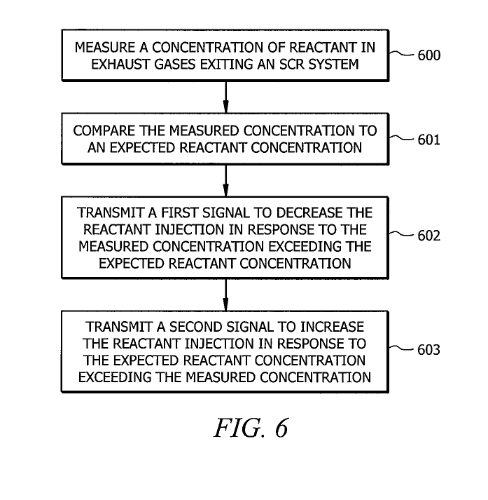

FIG. 6 is an operational block diagram illustrating example functional blocks executed to implement one embodiment of the present teachings. In block 600, a concentration of reactant is measured in the exhaust gases exiting an SCR system. The measured concentration is then compared to an expected reactant concentration in block 601. A first signal is transmitted, in block 602, to decrease the reactant injection in response to the measured concentration exceeding the expected reactant concentration. In block 603, a second signal is transmitted to increase the reactant injection in response to the expected reactant concentration exceeding the measured concentration.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine or computer readable medium tangibly embodying instructions may be used in implementing the methodologies described herein. For example, software code may be stored in a memory and executed by a processor. When executed by the processor, the executing software code generates the operational environment that implements the various methodologies and functionalities of the different aspects of the teachings presented herein. Memory may be implemented within the processor or external to the processor. As used herein the term “memory” refers to any type of long term, short term, volatile, nonvolatile, or other memory and is not to be limited to any particular type of memory or number of memories, or type of media upon which memory is stored.

The machine or computer readable medium that stores the software code defining the methodologies and functions described herein includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. As used herein, disk and/or disc includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

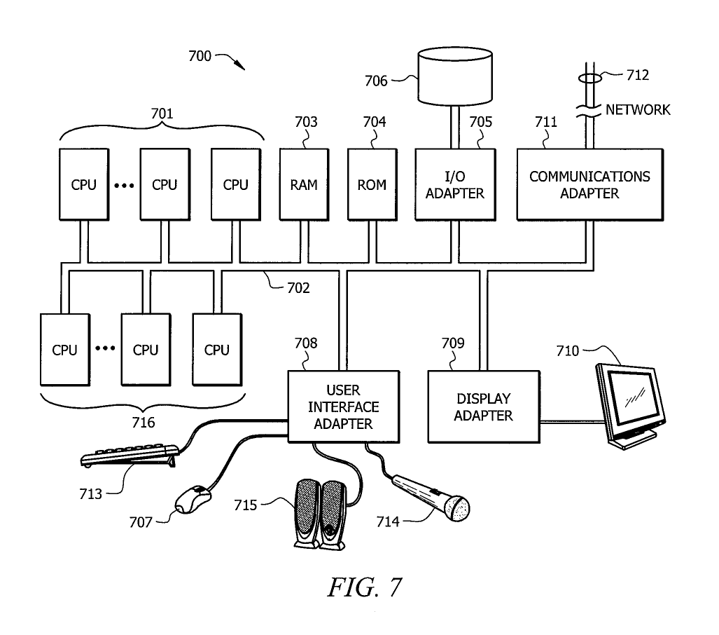

FIG. 7 illustrates an exemplary computer system 700 which may be employed to implement any of the white space devices configured according to certain embodiments of the present teachings. A central processing unit (“CPU” or “processor”) 701 is coupled to a system bus 702. The CPU 701 may be any general-purpose processor. The present disclosure is not restricted by the architecture of the CPU 701 (or other components of the exemplary computer system 700) as long as the CPU 701 (and other components of the exemplary computer system 700) supports the operations as described herein. As such the CPU 701 may provide processing to the exemplary computer system 700 through one or more processors or processor cores. The CPU 701 may execute the various logical instructions described herein. For example, the CPU 701 may execute machine-level instructions according to the exemplary operational flow described above in conjunction with FIGS. 8-12. When executing instructions representative of the functionalities illustrated in FIGS. 8-12, the CPU 701 becomes a special-purpose processor of a special purpose computing platform configured specifically to operate according to the various aspects of the teachings described herein.

The exemplary computer system 700 also includes random access memory (RAM) 703, which may be SRAM, DRAM, SDRAM, or the like. The exemplary computer system 700 includes read-only memory (ROM) 704 which may be PROM, EPROM, EEPROM, or the like. The RAM 703 and ROM 704 hold user and system data and programs, as is well known in the art.

The exemplary computer system 700 also includes an input/output (I/O) adapter 705, communications adapter 711, user interface adapter 708, and display adapter 709. The I/O adapter 705, user interface adapter 708, and/or the communications adapter 711 may, in certain aspects, enable a user to interact with the exemplary computer system 700 in order to input information.

The I/O adapter 705 couples a storage device(s) 706, such as one or more of a hard drive, compact disc (CD) drive, floppy disk drive, tape drive, etc., to the exemplary computer system 700. The storage devices 706 are utilized in addition to the RAM 703 for the memory requirements associated with performing the operations associated with the client and proxy multiradio devices and the network servers configured according to various aspects of the present teachings. The communications adapter 711 is adapted to couple the exemplary computer system 700 to a network 712, which may enable information to be input to and/or output from the exemplary computer system 700 via the network 712 (e.g., the Internet or other wide-area network, a local-area network, a public or private switched telephony network, a wireless network, or any combination of the foregoing). A user interface adapter 708 couples user input devices, such as a keyboard 713, a pointing device 707, and a microphone 714 and/or output devices, such as speaker(s) 715 to the exemplary computer system 700. The display adapter 709 is driven by the CPU 701 or by a graphical processing unit (GPU) 716 to control the display on a display device 710, for example, to display an incoming message or call on a client mobile device. A GPU 716 may be any various number of processors dedicated to graphics processing and, as illustrated, may be made up of one or more individual graphical processors. A GPU 716 processes the graphical instructions and transmits those instructions to a display adapter 709. The display adapter 709 further transmits those instructions for transforming or manipulating the state of the various numbers of pixels used by the display device 710 to visually present the desired information to a user. Such instructions include instructions for changing state from on to off, setting a particular color, intensity, duration, or the like. Each such instruction makes up the rendering instructions that control how and what is displayed on the display device 710.

It shall be appreciated that the present disclosure is not limited to the architecture of the exemplary computer system 700. For example, any suitable processor-based device may be utilized for implementing the cooperative operation of the multiradio devices, including without limitation personal computers, laptop computers, computer workstations, multi-processor servers, mobile telephones, and other such mobile devices. Moreover, certain aspects may be implemented on application specific integrated circuits (ASICs) or very large scale integrated (VLSI) circuits. In fact, persons of ordinary skill in the art may utilize any number of suitable structures capable of executing logical operations according to the aspects.

Although the present teachings and their advantages have been described in detail, it should be understood that various changes, substitutions and alterations can be made herein without departing from the technology of the teachings as defined by the appended claims. Moreover, the scope of the present application is not intended to be limited to the particular aspects of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding aspects described herein may be utilized according to the present teachings. Accordingly, the appended claims are intended to include within their scope such processes, machines, manufacture, compositions of matter, means, methods, or steps.

What is claimed is:

1. A method for controlling reactant injection into a selective catalytic reduction (SCR) system during non-steady-state operational conditions, said method comprising:
measuring a concentration of reactant in exhaust gases exiting said SCR system;
comparing said measured concentration to an expected reactant concentration;
in response to said measured concentration exceeding said expected reactant concentration, transmitting a first signal to decrease said reactant injection prior to said SCR system; and
in response to said expected reactant concentration exceeding said measured concentration, transmitting a second signal to increase said reactant injection.

2. The method of claim 1 further comprising:
monitoring operational conditions;
in response to said operation conditions achieving a steady-state, switching control of said reactant injection into said SCR system to a nitrous oxide (NOₓ)-based control mechanism.

3. The method of claim 1 further comprising:
monitoring operational conditions of an exhaust gas processing system including said SCR system;
in response to said operational conditions entering said non-steady-state conditions, triggering said measuring of said concentration of said reactant.

4. A reactant injection control mechanism for a selective catalytic reduction (SCR) system during non-steady-state operational conditions, said reactant injection control mechanism comprising:
means for measuring a concentration of reactant in exhaust gases exiting said SCR system;
means for comparing said measured concentration to an expected reactant concentration;
means, executable in response to said measured concentration exceeding said expected reactant concentration, for transmitting a first signal to decrease said reactant injection prior to said SCR system; and
means, executable in response to said expected reactant concentration exceeding said measured concentration, for transmitting a second signal to increase said reactant injection.

5. The reactant injection control mechanism of claim 4 further comprising:
means for monitoring operational conditions;
means, executable in response to said operation conditions achieving a steady-state, for switching control of said reactant injection into said SCR system to a nitrous oxide (NOₓ)-based control mechanism.

6. The reactant injection control mechanism of claim 4 further comprising:
means for monitoring operational conditions of an exhaust gas processing system including said SCR system;
means, executable in response to said operational conditions entering said non-steady-state conditions, for triggering said measuring of said concentration of said reactant.

7. A computer program product having a computer-readable medium with program code recorded thereon, said program code comprising:
program code to measure a concentration of reactant in exhaust gases exiting a selective catalytic reduction (SCR) system;
program code to compare said measured concentration to an expected reactant concentration;
program code, executable in response to said measured concentration exceeding said expected reactant concentration, to transmit a first signal to decrease said reactant injection prior to said SCR system; and
program code, executable in response to said expected reactant concentration exceeding said measured concentration, to transmit a second signal to increase said reactant injection.

8. The computer program product of claim 7 wherein said program code further comprises:
program code to monitor operational conditions; and
program code, executable in response to said operation conditions achieving a steady-state, to switch control of said reactant injection into said SCR system to a nitrous oxide (NOₓ)-based control mechanism.

9. The method of claim 7 further comprising:
monitoring operational conditions of an exhaust gas processing system including said SCR system;
in response to said operational conditions entering said non-steady-state conditions, triggering said measuring of said concentration of said reactant.

10. An emissions control system comprising:
an exhaust flue configured to contain exhaust gases produced by a pollution source, said pollution source coupled to said exhaust flue at a first end;
a reaction chamber positioned between said first end and a second end of said exhaust flue, said reaction chamber containing a catalyst bed;
an injection grid within said exhaust flue prior to said reaction chamber, said injection grid coupled to a reactant reservoir, wherein said injection grid injects reactant from said reactant reservoir into said exhaust gases within said exhaust flue;
a reactant injection controller coupled to said injection grid, wherein said reactant injection controller transmits signals to said reactant injection controller controlling an amount of said reactant injected into said exhaust gases;
a reactant detector within said exhaust flue after said reaction chamber, said reactant detector coupled to said reactant injection controller, wherein said reactant detector measures a concentration of reactant in said exhaust gases after passing over said catalyst bed in said reaction chamber;
a pollution source monitor coupled to said reactant injection controller, wherein said pollution source monitor monitors an operational condition of said pollution source, wherein, in response to said pollution source monitor detecting said pollution source in a non-steady-state operational condition, said pollution source monitor signals said reactant injection controller to use said concentration measured by said reactant detector in controlling said amount of said reactant injected into said exhaust gases during said non-steady-state operational condition.

11. The emissions control system of claim 10 wherein, in response to said pollution source monitor detecting said pollution source entering a steady-state operational condition, said pollution source monitor signals said reactant injection controller to cease using said concentration to control said amount of said reactant injected.

12. The emissions control system of claim 11 further comprising:
at least one nitrous oxide (NOₓ) detector within said exhaust flue and located at least after said reaction chamber, said NOₓ detector coupled to said reactant injection controller, wherein in response to said detection of said steady-state operational condition, said pollution source monitor signals said reactant injection controller to use a NOₓ concentration measured by said at least one NOₓ detector in controlling said amount of reactant injected.
